(19) United States
(12) Patent Application Publication
(10) Pub. No.: US 2016/0140935 A1
(43) Pub. Date: May 19, 2016

(54) DISPLAY DEVICE

(71) Applicant: Samsung Display Co., Ltd., Yongin-city (KR)

(72) Inventors: Young-Soo HWANG, Suwon-si (KR); Chang sin KIM, Suwon-si (KR)

(21) Appl. No.: 14/711,282

(22) Filed: May 13, 2015

(30) Foreign Application Priority Data
Nov. 13, 2014 (KR) 10-2014-0158096

(51) Int. Cl. G09G 5/18

(52) U.S. Cl. CPC G09G 5/18; G09G 2330/12

(57) ABSTRACT

A display device includes signal lines comprising gate lines and data lines, wherein a respective data line is disposed to intersect with the gate lines. The display device further includes a repair line and a switch configured to electrically connect the repair line to a signal line, wherein a defective signal line can be electrically connected to the repair line.

### CROSS-REFERENCE TO RELATED APPLICATION

This application claims priority from and the benefit of Korean Patent Application No. 10-2014-0158096, filed on Nov. 13, 2014, which is hereby incorporated by reference for all purposes as if fully set forth herein.

### BACKGROUND

1. Field

Exemplary embodiments relate to a display device, and more particularly, to a display device for improving repair characteristics.

2. Discussion of the Background

A display device can include a display panel for displaying an image, and a gate driver and a data driver which drive the display panel. The display panel can include gate lines, data lines, and pixels connected to the gate and data lines. The gate lines receive gate signals from the gate driver. The data lines receive data voltages from the data driver. The pixels receive data voltages through the data lines in response to gate signals applied to the gate lines. The pixels display gradations corresponding to the data voltages. Accordingly, images are displayed.

In the situation where any one signal line among the data and gate lines is disconnected, the display device fails to normally display an image.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a display device capable of normally displaying an image by electrically connecting a disconnected signal line to a repair line.

Additional aspects will be set forth in the detailed description which follows, and, in part, will be apparent from the disclosure, or may be learned by practice of the inventive concept.

According to one or more exemplary embodiments, a display device includes signal lines comprising gate lines and data lines, wherein a respective data line is disposed to intersect with the gate lines. The display device further includes a repair line and a switch configured to electrically connect the repair line to a signal line, wherein a defective signal line can be electrically connected to the repair line.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept and, together with the description, serve to explain principles of the inventive concept.

FIG. 1 is a block diagram of a display device according to one or more exemplary embodiments.

FIG. 2 is a block diagram illustrating an exemplary embodiment of a source driving chip illustrated in FIG. 1.

FIG. 3 is a block diagram illustrating an exemplary embodiment of the switch unit illustrated in FIG. 2.

FIG. 4 is a view illustrating that a disconnected signal line is connected to a repair line according to a repair method according to one or more exemplary embodiments.

### DETAILED DESCRIPTION OF THE EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

In order to solve a failures caused by the disconnection or discontinuity of a signal line, a repair method is disclosed to electrically connect the defective signal line to a repair line.

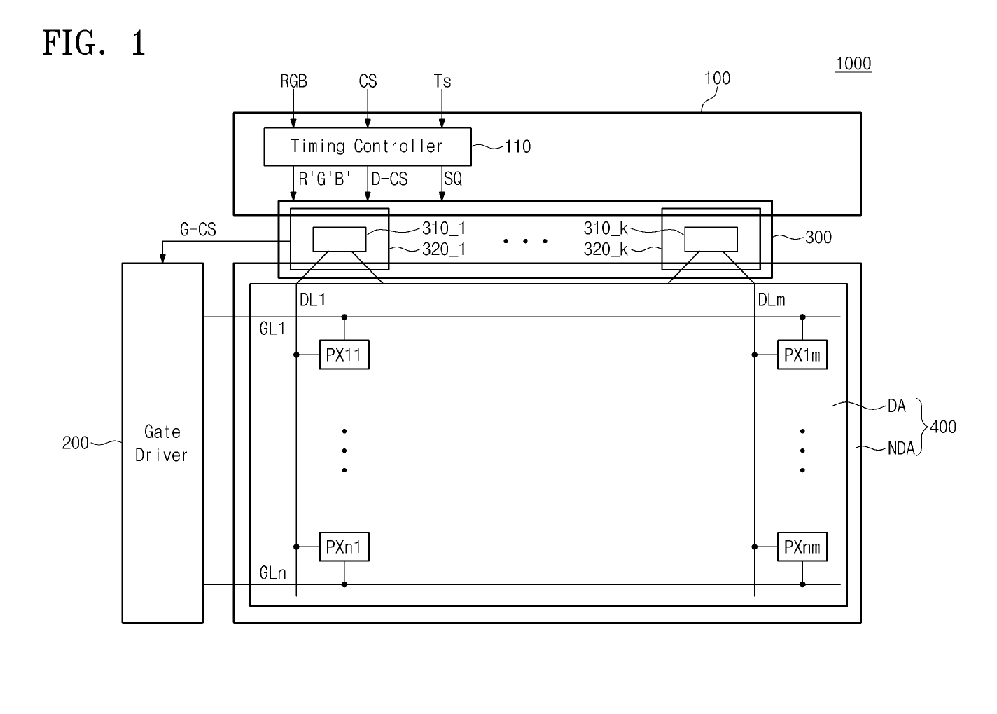

FIG. 1 is a block diagram of a display device according to one or more exemplary embodiments.

In FIG. 1, display device 1000 includes driving circuit substrate 100, gate driver 200, data driver 300, and display panel 400.

Driving circuit substrate 100 includes timing controller 110 controlling operation of display device 1000. Timing controller 110 receives a plurality of image signals RGB and a plurality of control signals CS from outside of display 1000. Timing controller 110 converts a data format of the image signals RGB to be consistent with the interface specification of data driver 300. A plurality of converted image signals R′G′B′ are provided to data driver 300.

Data driver 300 can include a plurality of source driving chips 310_1 to 310_k mounted on a plurality of source circuit substrates 320_1 to 320_k. Here, k is an integer greater than 0 and smaller than m. Source circuit substrates 320_1 to 320_k may be connected to driving circuit substrate 100 and a non-display area NDA adjacent to the top portion of a display area DA of display panel 400. Although an identical number of source driving chips as source circuit substrates are shown in FIG. 1, multiple source driving chips could be mounted to a single substrate.

Timing controller 110 may output a plurality of driving signals in response to external control signals CS. For example, timing controller 110 may generate data control signals D-CS and gate control signals G-CS as a plurality of driving signals. The data control signals D-CS may include an output start signal, a clock signal, a line latch signal, and the like. The gate control signals G-CS may include a vertical start signal, a vertical clock bar signal, and the like. Timing controller 110 delivers the data control signals D-CS to data driver 300 and the gate control signals G-CS to gate driver 200. For example, the timing controller 110 may deliver the gate control signals G-CS to gate driver 200 using a path over a source circuit substrate, such as 320_1, of the data driver 300, as illustrated in FIG. 1.

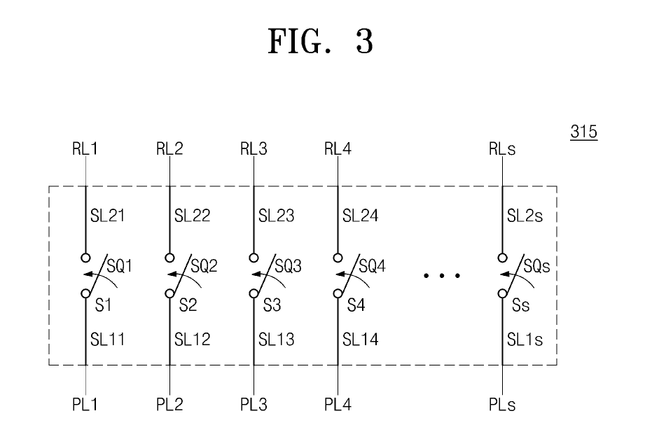

Timing controller 110 may receive a test signal Ts from outside of the display device 1000. As an example, the test signal Ts may be a signal to identify a disconnected or discontinuous signal line among the plurality of gate lines GL1 to GLn and the plurality of data lines DL1 to DLm disposed on the display panel 400. The test signal may also identify a repair line RL1 to RLs or a switch S1 to Ss described below in connection with FIG. 3. The test signal Ts may be output by an external test device for determining disconnection of a signal line.

Timing controller 110 may create a switching control signal SQ in response to the test signal Ts. The switching control signal SQ may be a control signal instructing a control operation for electrically connecting a disconnected signal line to a repair line. Timing controller 110 delivers the switching control signal SQ to data driver 300.

Gate driver 200 creates a plurality of gate signals in response to the gate control signals G-CS provided from timing controller 110. The gate signals can be provided sequentially and to rows of pixels PX11 to PXnm through gate lines GL1 to GLn. As a result, the pixels PX11 to PXnm may be driven by rows.

Data driver 300 receives the image signals R′G′B′, the data control signals D-CS, and the switching control signal SQ from the timing controller 110. Data driver 300 creates a plurality of data voltages corresponding to the image signals R′G′B′ in response to the data control signals D-CS. Data driver 300 provides the data voltages to the plurality of pixels PX11 to PXnm through the data lines DL1 to DLm.

In the situation where a data line among the data lines DL1 to DLm is disconnected or discontinuous, the defective data line may be electrically connected to a repair line according to an activation state of the switching control signal SQ. In such a way, as the disconnected data line is electrically connected to the repair line, the data driver 300 may provide a data voltage to a corresponding pixel through the repair line. This operation is described in detail in relation to FIG. 3. Source driving chips 301_1 to 310_k can be mounted on source circuit substrates 320_1 to 320_k in a tape carrier package (TCP) structure. However, the invention is not limited to the use of a TCP structure. For example, source driving chips 310_1 to 310_k may be mounted on the source circuit substrates 320_1 to 320_k in a chip on glass (COG) structure or other suitable structure for mounting source driving chip(s).

Display panel 400 includes the display area DA displaying an image and the non-display area NDA disposed around the display area DA.

Display panel 400 may include the plurality of pixels PX11 to PXnm disposed on the display area DA. Display panel 400 may also include gate lines GL1 to GLn and data lines DL1 to DLm insulated from and intersected with gate lines GL1 to GLn.

Gate lines GL1 to GLn may be connected to the gate driver 200 and receive sequential gate signals. Data lines DL1 to DLm may be connected to the data driver 300 and receive the data voltages.

Pixels PX11 to PXnm may be formed between areas at which the gate lines GL1 to GLn intersect with the data lines DL1 to DLm. Accordingly, pixels PX11 to PXnm may be arrayed with n rows and m columns. Here, n and m are integers greater than 0.

Pixels PX11 to PXnm are respectively connected to corresponding gate lines GL1 to GLn and corresponding data lines DL1 to DLm. Pixels PX11 to PXnm receive the data voltages through data lines DL1 to DLm in response to the gate signals provided through gate lines GL1 to GLn. As a result, pixels PX11 to PXnm may display gradations corresponding to the data voltages.

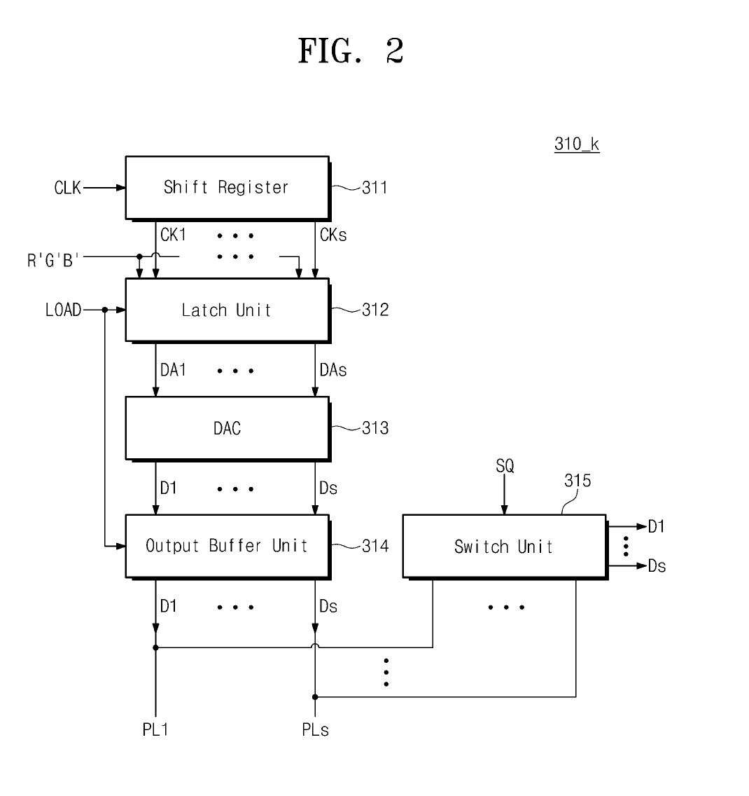

FIG. 2 is a block diagram illustrating an exemplary embodiment of a source driving chip illustrated in FIG. 1. FIG. 3 is a block diagram illustrating an exemplary embodiment of the switch unit illustrated in FIG. 2.

Source driving chip 310_k illustrated in FIG. 2 may be any one of the plurality of source driving chips 310_1 to 310_k illustrated in FIG. 1. Although one source driving chip 310_k is exemplarily described in relation to FIG. 2, configurations and operation schemes of source driving chips may be the same.

Referring to FIG. 2, source driving chip 310_k may include shift register 311, latch unit 312, digital-to-analog converter 313, output buffer unit 314, and switch unit 315. A clock signal CLK and a line latch signal LOAD may be included, as for example illustrated in FIG. 2, in the data control signals D-CS provided from the timing controller 110 (see FIG. 1). However, the invention is not limited to the use of these particular control signals or to the arrangement of control signals shown, and the data control signals D-CS may include various control signals.

Shift register 311 receives latch clock signals CK1 to CKs and image signals R′G′B′ provided from the timing controller 110 (see FIG. 1). Shift register 311 sequentially activates a plurality of latch clock signals CK1 to CKs in response to the clock signal CLK.

Latch unit 312 latches the image signals R′G′B′ in response to the latch clock signals CK1 to CKs provided from shift register 311. Latch unit 312 provides the latched digital image signals DA1 to DAs to the digital-to-analog converter 313 in response to the line latch signal LOAD.

Digital-to-analog converter 313 receives the digital image signals DA1 to DAs from latch unit 312. Digital-to-analog converter 313 converts the received digital image signals DA1 to DAs into a plurality of data voltages D1 to Ds. Although not illustrated in drawing, the digital-to-analog converter 313 may receive a plurality of gamma voltages from an external source. Digital-to-analog converter 313 may output the data voltages D1 to Ds corresponding to the digital image signals DA1 to DAs on the basis of the gamma voltages.

Output buffer unit 314 receives the data voltages D1 to Ds from digital-to-analog converter 313. Output buffer unit 314 simultaneously outputs the data voltages D1 to Ds to a plurality of driving lines PL1 to PLs in response to the line latch signal LOAD. Driving lines PL1 to PLs are electrically connected to data lines DL1 to DLs disposed on the display panel 400. The data voltages D1 to Ds may be provided to data lines DL1 to DLs through driving lines PL1 to PLs.

Switch unit 315 may be used for the case where one of the data lines DL1 to DLs is defective, such as being disconnected or discontinuous. Switch unit 315 operates to connect the disconnected data line to a repair line in response to the switching control signal SQ provided from timing controller 110.

In more detail, referring to FIG. 3, switch unit 315 includes a plurality of switches S1 to Ss, a plurality of first switch lines SL11 to SL1s, and a plurality of second switch lines SL21 to SL2s.

One end of a switch of switches S1 to Ss is connected to a first switch line of switch lines SL11 to SL1s and the first switch line (SL1x, e.g.) is electrically connected to a driving line of driving lines PL1 to PLs. As the first switch lines SL11 to SL1s are electrically connected to the driving lines PL1 to PLs, data voltages D1 to Ds output from the output buffer unit 314 may be provided to the switches S1 to Ss.

The other end of a switch of switches S1 to Ss is connected to a second switch line of the switch lines SL21 to SL2s, and the second switch lines SL21 to SL2s are electrically connected to repair lines RL1 to RLs. As the second switch lines SL21 to SL2s are electrically connected to the repair lines RL1 to RLs, data voltages D1 to Ds delivered through the switches S1 to Ss may be delivered to the repair lines RL1 to RLs. Switches S1 to Ss may be turned on in response to switching control signals SQ1 to SQs in an activation mode. Switches S1 to Ss may be operated in an activation mode or in a non-activation mode according to switching control signals SQ1 to SQs provided from timing controller 110.

Although it is described that switch unit 315 includes the plurality of switches S1 to Ss, the invention is not limited to the number and arrangement of switches. Switch unit 315 may only include a respective switch for repairing a disconnected or defective data lines among data lines DL1 to DLs. In other words, rather than providing a switch for each signal line, display device 1000 may include a number of switches that corresponds to the number of disconnected data lines (actually determined or a maximum number of predicted). In addition, display device 1000 may include at least one repair line corresponding to the number of disconnected data lines (actually determined or predicted).

Timing controller 110 may determine a mode of the switching control signals SQ1 to SQs according to whether there is a disconnected data line among data lines DL1 to DLs. Whether there is a disconnected data line among the data lines DL1 to DLs may be determined by an external test device in a process of manufacturing display device 1000.

As an example, timing controller 110 receives, from the external test device, a test signal including information identifying the disconnected data lines among data lines DL1 to DLs. Timing controller 110 performs a control operation in response to the test signal so that switches corresponding to the disconnected data lines are turned on. For example, the control operation can include timing controller 110 outputting a switching control signal in an activation mode to the corresponding switches. As a result, the switches corresponding to the disconnected data lines are turned on and the disconnected data lines may be electrically connected to the repair lines.

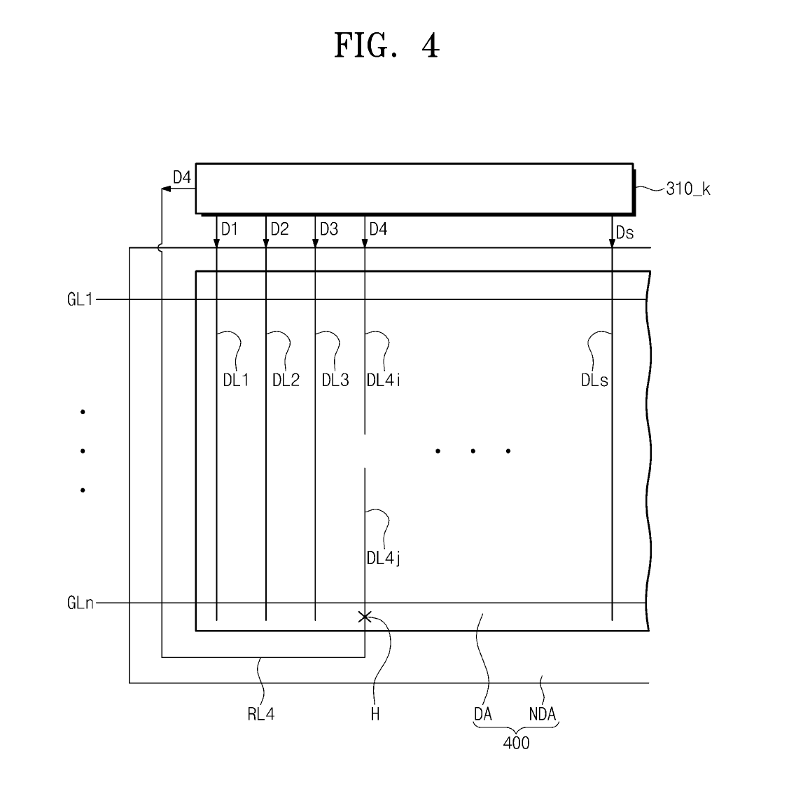

FIG. 4 is a view illustrating that a disconnected signal line is connected to a repair line according to a repair method according to one or more exemplary embodiments.

Referring to FIGS. 3 and 4, a method that connects a disconnected signal line to a repair line is described. For purposes of discussion, it is described below that a fourth data line DL4 among the data lines DL1 to DLs is disconnected. In other words, a first disconnected line DL4i disposed above the center of display panel 400 is not connected to a second disconnected line DL4j disposed below the center of display panel 400. First disconnected line DL4i may be connected to source driving chip 310_k.

First disconnected line DL4i may be connected to a fourth driving line PL4 illustrated in FIG. 3. Fourth driving line PL4 may be connected to a fourth switch line SL14 connected to one end of the fourth switch S4. First disconnected line DL4i may receive a data voltage output from the output buffer unit 314.

Second disconnected line DL4j may be electrically connected to a fourth repair line RL4. For example, fourth repair line RL4 may be connected to the second disconnected line DL4j through laser welding H. As described in relation to FIG. 3, fourth repair line RL4 is electrically connected to a fourth switch line SL24. In addition, fourth repair line RL4 connected to fourth switch line SL24 may be connected to the second disconnected line DL4j in the region of non-display area NDA.

In some exemplary embodiments, display lines DL1 to DLm can each be connected to a respective repair line RL1 to RLm. In other exemplary embodiments, during manufacture, display device 1000 can be tested to determine proper operation of display panel 400 and defective display lines DL1 to DLm can be selectively connected to an associated repair line. In this manner, the number of repair lines does not have to equal the number of signal lines.

Timing controller 110 (see FIG. 1) receives a test signal including disconnection information regarding the fourth data line DL4. Timing controller 110 outputs the fourth switching control signal SQ4 for activating the fourth switch S4 to source driving chip 310_k in response to the test signal. As the fourth switch S4 is turned on in response to the fourth switching control signal SQ4 in the activation mode, first disconnected line DLi4 and fourth repair line RL4 are electrically connected.

As an example, when the test signal indicates that the data line associated with a particular switch is defective (such as the data line associated with the fourth switch S4 of source driving chip 310_k), timing controller 110 outputs only the fourth switching control signal SQ4 in the activation mode to the source driving chip 310_k and not to other source driving chips having a switch SQ4. Further, when the plurality of switches S1 to Ss are included in source driving chip 310_k, timing controller 110 may output the fourth switching control signal SQ4 in the activation mode and switching control signals in the non-activation mode respectively corresponding to the remaining switches.

In other words, timing controller 110 outputs a switching control signal in the activation mode to a switch that is a repair target among the switches disposed in the switch unit 315 in order to repair the disconnected data line. As a result, a data voltage output from the output buffer unit 314 may be provided to the repair line through the switch.

According to the above-described operation, the fourth data voltage D4 output through the source driving chip 310_k may be provided to the first disconnected line DL4i and the fourth repair line RL4. In addition, as the fourth repair line RL4 can be electrically connected to the second disconnected line DL4j, the fourth data voltage D4 may be provided to the second disconnected line DL4j. As a result, the fourth data voltage D4 may be provided to pixels connected to the second disconnected line DL4j.

Although it is described herein that one fourth data line DL4 is disconnected, the aforementioned technical features may also be applied to a case where a plurality of data lines are disconnected.

In addition, although description is provided herein on the basis of a case where data lines are disconnected, the invention is not limited to defective data lines. The configuration of the switch unit according to an exemplary embodiment may also be applied to a case where gate lines are defective. For example, a gate driving chip included in the gate driver may include the configuration of the above-described switch unit.

Accordingly, display device 1000 according to exemplary embodiments may normally provide data voltages to pixels by connecting a disconnected signal line to a repair line through the configuration of a switch unit.

According to embodiments of the inventive concept, when a signal line is disconnected, the disconnected signal line can be electrically connected to a repair line and accordingly, driving voltages can be provided to pixels. As a result, an image can be normally displayed.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display device comprising:
signal lines, comprising:
gate lines; and
data lines, wherein a respective data line is disposed to intersect with the gate lines;
a repair line; and
a switch configured to electrically connect the repair line to a signal line, wherein a defective signal line can be electrically connected to the repair line.

2. The display device of claim 1, further comprising a timing controller configured to output a switching control signal in response to a test signal received from outside the display device,
wherein the switch is turned on according to an activation state of the switching control signal.

3. The display device of claim 2, wherein the test signal comprises information to identify at least one of the defective signal line, the repair line, and the switch.

4. The display device of claim 2, wherein the timing controller is configured to perform a control operation to activate the switch to connect the defective signal line to the repair line.

5. The display device of claim 1, further comprising a plurality of repair lines, wherein the number of repair lines corresponds to a number of defective signal lines.

6. The display device of claim 1, further comprising a plurality of switches, wherein the number of switches corresponds to the number of data lines.

7. The display device of claim 1, wherein the switch is a portion of a data driver circuit.

8. The display device of claim 7, wherein the defective signal line is a data line, and
wherein the defective data line comprises a first line portion and a second line portion disconnected from each other.

9. The display device of claim 8, wherein the data driver circuit further comprises an output buffer unit outputting a plurality of data voltages for displaying an image.

10. The display device of claim 9, wherein the data driver circuit further comprises:
a driving line electrically connecting the first line portion to the output buffer unit;
a first switch line connecting the driving line and the switch; and
a second switch line electrically connecting the repair line and the switch, wherein the second line portion is connected to the repair line.

11. The display device of claim 10, wherein the driving line is electrically connected to the first line portion.

12. The display device of claim 8, wherein the second line portion is electrically connected to the repair line.

13. The display device of claim 1, wherein the display device includes a display area where the signal lines are disposed and a non-display area and wherein the repair line is disposed in the non-display area.

14. The display device of claim 1, further comprising the switch is a portion of a gate driver circuit,
wherein the defective line is a gate line and wherein the switch electrically connects the defective gate line to the repair line.
